(19) United States
(12) Patent Application Publication
(10) Pub. No.: US 2026/0104976 A1
(43) Pub. Date: Apr. 16, 2026

(54) DEBUGGING METHOD, ELECTRONIC APPARATUS, AND COMPUTER READABLE STORAGE MEDIUM

(71) Applicant: Samsung Electronics Co., Ltd., Suwon-si (KR)

(72) Inventors: Linxuan LIU, Xi'an (CN); Mao ZHANG, Xi'an (CN)

(73) Assignee: Samsung Electronics Co., Ltd., Suwon-si (KR)

(21) Appl. No.: 18/936,073

(22) Filed: Nov. 4, 2024

(30) Foreign Application Priority Data
Oct. 12, 2024 (CN) 202411420886.5

(51) Int. Cl. G06F 11/263

(52) U.S. Cl. CPC G06F 11/263

(57) ABSTRACT

A debugging method includes: sending an ID of a debugged device to a client in response to receiving a debugging request from the client; receiving credential information from the client and receiving a public key corresponding to the ID of the debugged device from the client, obtaining target encrypted information by using an Authenticated Encryption with Associated Data (AEAD) encryption algorithm based on the received public key and the received credential information, and sending the target encrypted information to the client, wherein the received credential information is generated based on a user credential and a challenge value corresponding to the received public key; and enabling a debugging right in response to receiving encrypted debugging control information from the client, wherein the encrypted debugging control information is generated based on the target encrypted information.

### CROSS-REFERENCE TO RELATED APPLICATION

This application is based on and claims priority under 35 U.S.C. § 119 to Chinese Patent Application No. 202411420886.5, filed on Oct. 12, 2024 in the Chinese Patent Office, the disclosure of which is incorporated by reference herein in its entirety.

### BACKGROUND

### Field

The present inventive concepts relate to the field of chip debugging technology, and particularly relates to debugging methods, electronic apparatuses, and computer readable storage mediums.

### Related Art

A security debugging function is widely present in current embedded apparatuses, and is generally used for debugging a device during a development phase and locating problematic products during a commercial phase. Generally, to ensure data security of the debugged device, a debugging interface of the device is in a closed state by default. When security debugging is enabled, an identity of a debugger is authenticated, and only the authenticated users can access the debugging interface of the debugged device through a host, thereby ensuring a data security of the device through this manner.

In related art, a client typically requires security authentication with a server. To protect a user credential, SSL/TLS (Secure Sockets Layer/Transport Layer Security) can be used to establish a secure channel between the client and the server. However, the current SSL/TLS does not have a quantum-resistant ability and is unable to resist quantum attacks, and establishing the secure channel using the SSL/TLS may introduce an additional key distribution issue. If a combination of an authentication based on an enhanced challenge response and digital signature in the existing authentication scheme is adopted to perform the authentication after the signature is verified (e.g., in response to verification of the signature), a public key length of PQC (Post quantum cryptography resistant) signature algorithm is too long, resource consumption is too high, and latency is high.

### SUMMARY

Some example embodiments of the present inventive concepts provide at least one of a debugging method, an electronic apparatus, or a computer readable storage medium. In the least one of the debugging method, the electronic apparatus, or the computer readable storage medium, identity authentication may be performed based on an unsigned algorithm and a protection mechanism may be used for user credential information to reduce resource consumption and ensure transmission security.

In some example embodiments of the present inventive concepts, a debugging method may include: sending an identifier (ID) of a debugged device to a client in response to receiving a debugging request from the client; receiving, from the client, a public key corresponding to the ID of the debugged device and credential information, obtaining target encrypted information by using an Authenticated Encryption with Associated Data (AEAD) encryption algorithm based on the received public key and the received credential information, sending the target encrypted information to the client, wherein the received credential information is generated based on a user credential and a challenge value corresponding to the received public key, receiving encrypted debugging control information from the client, the encrypted debugging control information being generated based on the target encrypted information, and enabling a debugging right in response to receiving the encrypted debugging control information.

In some example embodiments of the present inventive concepts, a debugging method may include: obtaining a public key corresponding to an identifier (ID) of a debugged device; receiving, from a client, the ID of the debugged device; generating a challenge value corresponding to the public key in response to receiving the ID of the debugged device; sending the public key and the challenge value to the client; receiving target encrypted information from the client; obtaining decrypted credential information using an AEAD decryption algorithm based on target encrypted information in response to receiving the target encrypted information; verifying the decrypted credential information; and generating encrypted debugging control information and sending the encrypted debugging control information to the client in response to a determination that the verification of the decrypted credential information is successful, wherein the encrypted debugging control information indicates that the debugged device connected to the client has enabled a debugging right.

In some example embodiments of the present inventive concepts, an electronic apparatus may include: an information transceiving unit, configured to send an identifier (ID) of a debugged device to a client in response to receiving a debugging request from the client; a target encrypted information acquisition unit, configured to receive, from the client, a public key corresponding to the ID and credential information, obtain target encrypted information by using an Authenticated Encryption with Associated Data (AEAD) encryption algorithm based on the received public key and the received credential information, and send the target encrypted information to the client, wherein the received credential information is generated based on a user credential and a challenge value corresponding to the public key; and a debugging right enabling unit, configured to receive encrypted debugging control information from the client, the encrypted debugging control information being generated based on the target encrypted information, and enable a debugging right in response to receiving the encrypted debugging control information.

According to some example embodiments of the present inventive concepts, an electronic apparatus may include: an information transceiving unit, configured to obtain a public key corresponding to an identifier (ID) of a debugged device, receive, from a client, the ID of the debugged device, generate a challenge value corresponding to the public key in response to receiving the ID of the debugged device, and send the public key and the challenge value to the client; a credential information acquisition unit, configured to receive target encrypted information from the client, and obtain decrypted credential information using an AEAD decryption algorithm based on target encrypted information in response to receiving the target encrypted information, and verify the decrypted credential information; and an encrypted debugging control information generation unit, configured to generate encrypted debugging control information and send the encrypted debugging control information to the client in response to a determination that the verification of the decrypted credential information is successful, wherein the encrypted debugging control information indicates that the debugged device connected to the client has enabled a debugging right.

The debugging method, the electronic apparatus, and the computer readable storage medium according to some example embodiments of the present inventive concepts may utilize the key encapsulation mechanism to ensure security of the public key by generating the first key using the public key corresponding to the device ID and based on the key encapsulation mechanism, then encrypting the credential information of a user according to the first key, and further completing information transmission. Meanwhile, the AEAD encryption algorithm can be used to encrypt the user credential, thereby ensuring security of transmitting the user credential.

### BRIEF DESCRIPTION OF THE DRAWINGS

The above and other objects, features and advantages of the present inventive concepts will become clearer through the following description taken in conjunction with the accompanying drawings, in which:

FIG. 1 is a diagram illustrating an example architecture of a debugging system according to some example embodiments of the present inventive concepts;

FIG. 2 is a flowchart illustrating a debugging method of the debugging system according to some example embodiments of the present inventive concepts;

FIG. 3 is a flowchart illustrating a debugging method according to some example embodiments of the present inventive concepts;

FIG. 4 is a flowchart illustrating a debugging method according to some example embodiments of the present inventive concepts;

FIG. 5 is a block diagram illustrating an electronic apparatus according to some example embodiments of the present inventive concepts;

FIG. 6 is a block diagram illustrating an electronic apparatus according to some example embodiments of the present inventive concepts; and

FIG. 7 is a block diagram illustrating an electronic apparatus according to some example embodiments of the present inventive concepts.

### DETAILED DESCRIPTION

Hereinafter, various example embodiments of the present inventive concepts are described with reference to the accompanying drawings, in which like reference numerals are used to depict the same or similar elements, features, and structures. However, the present inventive concepts are not intended to be limited by the various example embodiments described herein to a specific example embodiment and it is intended that the present inventive concepts cover all modifications, equivalents, and/or alternatives of the present inventive concepts, provided they come within the scope of the appended claims and their equivalents. The terms and words used in the following description and claims are not limited to their dictionary meanings, but are merely used to enable a clear and consistent understanding of the present inventive concepts. Accordingly, it should be apparent to those skilled in the art that the following description of various example embodiments of the present inventive concepts is provided for illustration purpose only and not for the purpose of limiting the present inventive concepts as defined by the appended claims and their equivalents.

It is to be understood that the singular forms include plural forms, unless the context clearly indicates otherwise. The terms “include”, “comprise”, and “have” used herein, indicate disclosed functions, operations, or the existence of elements, but do not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In various example embodiments of the present inventive concepts, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to” used in describing various embodiments of the present inventive concepts, may be used interchangeably with expressions such as “suitable for”, “having the capacity to . . . ”, “designed to”, “adapted to”, “made to” and “capable of”, for example, according to the situation. The term “configured to” may not necessarily indicate “specifically designed to” in terms of hardware. Instead, the expression “a device configured to . . . ” in some situations may indicate that the device and another device or part are “capable of . . . ”. For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe some example embodiments of the present inventive concepts, but are not intended to limit the scope of other example embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present inventive concepts are not intended to be interpreted as excluding example embodiments of the present inventive concepts.

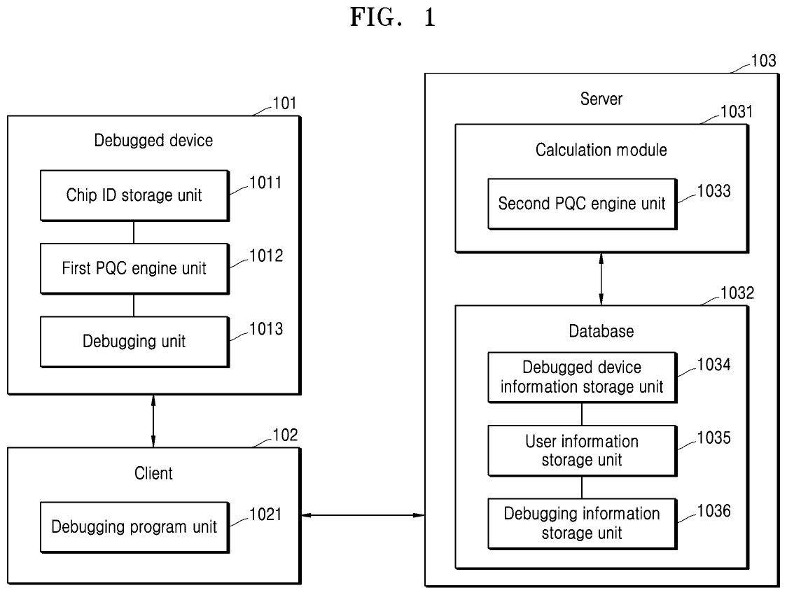

FIG. 1 is a diagram illustrating an example architecture of a debugging system according to some example embodiments of the present inventive concepts.

Referring to FIG. 1, the debugging system according to some example embodiments of the present inventive concepts includes a debugged device 101, a client 102 and a server 103. The client 102 is communicably connected with the debugged device 101 and the server 103 respectively.

Furthermore, the debugged device 101 may include a chip ID storage unit 1011, a first PQC engine unit 1012 and a debugging unit 1013. Among them, the chip ID storage unit 1011 stores device information of the debugged device 101, the first PQC engine unit 1012 participates in PQC algorithm calculation of an authentication protocol, and the debugging unit 1013 provides a debugging function to a user who has passed security debugging authentication. The client 102 may include a debugging program unit 1021. The client 102 receives a user credential of the user in a security protocol and serves as an intermediary for interaction between the debugged device 101 and the server 103. The client 102 may send debugging instructions to the debugged device 101 through the debugging program unit 1021. The server 103 may include a calculation module 1031 and a database 1032, in which the calculation module 1031 may include a second PQC engine unit 1033. The calculation module 1031 may perform the PQC algorithm calculation on the security protocol through the second PQC engine unit 1033. The database 1032 is used to record sensitive data in the security debugging authentication protocol. For example, the database 1032 may include a debugged device information storage unit 1034, a user information storage unit 1035, and a debugging information storage unit 1036.

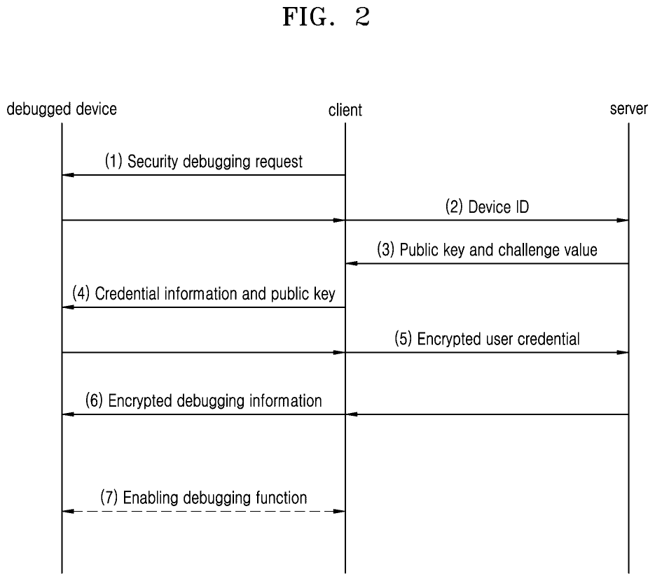

FIG. 2 is a flowchart illustrating a debugging method of the debugging system according to some example embodiments of the present inventive concepts.

Referring to FIG. 2, a client (which may be the client 102 shown in FIG. 1) receives a security debugging request from a user (e.g., a user supported by the client, where the request is received based on user interaction with a user interface of the client) and sends the security debugging request to a debugged device (which may be the debugged device 101 shown in FIG. 1) (1). The debugged device sends a device ID to the client based on the security debugging request, and the client sends the device ID to a server (which may be the server 103 shown in FIG. 1) (2). The server determines a corresponding public key based on the device ID, generates a challenge value, and then sends the public key and challenge value to the client (3). The client generates credential information (e.g., decrypted credential information) according to a received user credential and challenge value, and sends the credential information and the public key to the debugged device (4). The debugged device encrypts the user credential based on the received credential information and public key, and forwards an encrypted user credential to the client, and then the client sends the encrypted user credential to the server (5). The server decrypts the encrypted user credential according to a private key corresponding to the public key, determines corresponding debugging information according to the user credential and the device ID, and sends encrypted debugging information to the client after (e.g., in response to) encrypting the debugging information, and then the client forwards it (e.g., the decrypted encrypted debugging information) to the debugged device (6). The debugged device decrypts the received encrypted debugging information and enables a debugging function (e.g., enables a debugging right, which may include enabling the debugging function to be performed with regard to the client and the debugged device) according to the decrypted debugging information, thereby allowing the client to debug the debugged device (7). In this way, by performing a key encapsulation on the public and private keys corresponding to the device ID to obtain the same key, and performing encrypting and decrypting operations by the key for communication, resource consumption of a signature algorithm of PQC may be avoided (e.g., reduced or minimized), and a running latency may be reduced. As a result, performance of the debugged device, the client, the server, or any combination thereof (e.g., improved power consumption efficiency, reduced power consumption, improved operating speed, reduced latency of operations, or any combination thereof) may be improved. In addition, by encrypting the user credential, it is possible to ensure that the user credential will not be sent to the debugged device in a plaintext form, while ensuring security of the user credential in the debugged device. As a result, the security and reliability of the debugged device, the client, the server, or any combination thereof may be improved.

In addition, according to some example embodiments of the present inventive concepts, hardware of the debugged device includes, but is not limited to, integrated chips of various electronic apparatuses, including SSD controllers, mobile phone chips, car chips, and various device chips having debugging needs. Hardware of the debugged device may also include chips sold to other chip companies. Furthermore, software for running the debugging method according to some example embodiments of the present inventive concepts may include software running on the client and software running on the server, in which the software running on the client may be combined with debugging protocols such as JTAG, ADB, OBD, etc., and provided to the user in conjunction with the hardware.

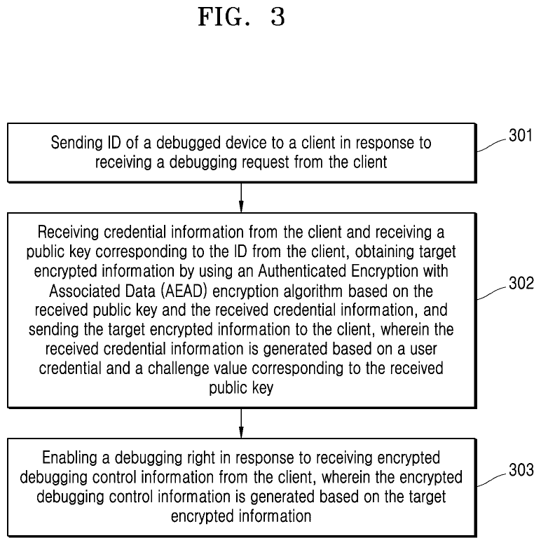

The debugging method and electronic apparatus according to some example embodiments of the present inventive concepts will be described below in detail referring to FIGS. 3-5.

FIG. 3 is a flowchart illustrating a debugging method according to some example embodiments of the present inventive concepts. The debugging method as shown in FIG. 3 may be applied to a debugged device. For example, the debugging method as shown in FIG. 3 may be implemented by a debugged device, including for example the debugged device 101 shown in FIG. 1.

Referring to FIG. 3, in step 301, in response to receiving a debugging request from a client, ID of a debugged device (also referred to herein interchangeably as a device ID) will be sent to the client. Here, the debugged device receives the debugging request from the client, reads the ID of the debugged device (i.e. device identity information) from, for example, a chip ID storage unit according to the debugging request, and sends the ID to the client.

In step 302, it is possible to receive credential information and a public key corresponding to the ID of the debugged device from the client (e.g., receive credential information from the client and receive a public key corresponding to the ID of the debugged device from the client, where the credential information and the public key may be received together or separately), obtain target encrypted information by using an Authenticated Encryption with Associated Data (AEAD) encryption algorithm based on the received public key and credential information (e.g., decrypted credential information), and send the target encrypted information to the client, where the credential information (e.g., decrypted credential information is generated based on a user credential and a challenge value corresponding to the public key. Here, the credential information is obtained by performing a hash operation on the user credential received from the user and the challenge value corresponding to the public key by the client, for example, Credentials hash=hash (Creds|Challenge), where hash is the hash operation, Creds is the user credential, Challenge is the challenge value, and Credentials hash is the credential information. The debugging method may reduce, minimize, or prevent malicious attacks from the debugged device by performing the hash processing on the user credential. In addition, the debugging method may enhance security of the credential information by performing the hash processing on the challenge value and the user credential together. As a result, the security of the debugging method, and thus the security of the debugged device, may be improved.

Specifically, when (e.g., in response to) the debugged device sends the ID to the client and receives the credential information and the public key corresponding to the ID from the client, the AEAD encryption algorithm is applied (e.g., at the debugged device) to the credential information according to the received public key to obtain target encrypted information, and the target encrypted information is sent to the client. The AEAD is an encryption form that combines confidentiality, integrity, and authentication.

According to some example embodiments of the present inventive concepts, the target encrypted information may be obtained (e.g., by the debugged device) by the following steps: verifying the received public key based on pre-stored public key information (which may be stored at a memory of the debugged device); and in response to the verification being successful (e.g., in response to a determination that the verification of the received public key is successful, such that the public key is verified), obtaining the target encrypted information using the AEAD encryption algorithm based on the received public key and credential information.

Here, the pre-stored public key information may be, for example, a hash value of a pre-stored public key corresponding to the ID in an internal OTP (one-time programmable) memory of the debugged device. Verifying the received public key refers to verifying whether the hash value of the pre-stored public key is consistent with the hash value of the received public key, for example, ASSERT (PK_hash==hash (PK)), where ASSERT is a verification algorithm, PK_hash is the hash value of the public key pre-stored in the OTP memory, and hash (PK) is the hash value of the public key received by the debugged device. If the verification is successful, the AEAD encryption algorithm is applied to the credential information according to the received public key to obtain the target encrypted information, and the target encrypted information is sent to the client. By verifying the received public key, it is possible to preliminarily determine whether the public key and credential information are correct, thereby ensuring the security and reliability of the user credential during information transmission. As a result, the security of the debugging method, and thus the security of the debugged device, may be improved.

According to some example embodiments of the present inventive concepts, the target encrypted information may be further obtained (e.g., at the debugged device) by the following steps: generating a first key and corresponding ciphertext by using a key encapsulation mechanism based on the public key, performing AEAD encryption on the credential information according to the first key to obtain the encrypted credential information, and finally using the encrypted credential information and the corresponding ciphertext as the target encrypted information.

Here, after (e.g., in response to) receiving the public key and verifying it (the public key) successfully, the debugged device may generate the first key and the corresponding ciphertext using the key encapsulation mechanism according to the public key, that is, Master_key, C=KEM_ENCAPS (PK), where Master_key is referred to as the first key hereinafter, C is the ciphertext (e.g., corresponding ciphertext), KEM_ENCAPS is the key encapsulation algorithm, and PK is the public key. By constructing the key encapsulation mechanism according to the public key, the first key and the ciphertext are obtained, and then the AEAD encryption is performed on the credential information using the first key, which may ensure that the keys obtained by both encryption and decryption parties are consistent during a decryption process, and relevant information of the first key is not leaked, thereby ensuring the security of information transmission. As a result, the security and/or reliability of the debugging method may be improved, the security and/or reliability of the debugged device, the client, and/or the server may be improved, or any combination thereof.

Furthermore, when the AEAD encryption is performed (e.g., at the debugged device) on the credential information according to the first key, the credential information may be encrypted according to the first key and first preset associated data to obtain the encrypted credential information. The first preset associated data indicates that the encrypted credential information comes from (e.g., originates from, originates at, is received from, etc.) the debugged device. Here, the first preset associated data corresponds to the ID of the debugged device and may be stored in advance in the debugged device (e.g., at a memory of the debugged device) for binding with the encrypted credential information to indicate that the encrypted credential information comes from the debugged device. In this way, before the server performs a decryption operation, it (the debugging method, or the server, debugged device and/or client performing any portion thereof) may first determine that the encrypted credential information comes from (e.g., originates from, is received from, etc.) the debugged device. As a result, the security of the debugging method, and thus the security of the debugged device, the client, and/or the server may be improved.

Encrypting the credential information according to the first preset associated data and the first key may be represented as: Enc_creds=AEAD-ENC (Master_key, Creds_hash, AD1), where Enc_creds is the encrypted credential information, AEAD-ENC is the AEAD encryption algorithm, Master_key is the first key, Creds_hash is the credential information (i.e. the information to be encrypted), and AD1 is the first preset associated data. Performing the AEAD encryption on the credential information as described above may provide privacy, integrity, and authenticity assurance of the credential information, as well as integrity assurance for unencrypted associated data (i.e., the first preset associated data).

Referring to FIG. 3 again, in step 303, a debugging right may be enabled in response to receiving encrypted debugging control information from the client (e.g., in response to a determination at the debugged device that the encrypted debugging control information is received at the debugged device from the client), where the encrypted debugging control information is generated based on the target encrypted information. Step 303 may include receiving encrypted debugging control information from the client, the encrypted debugging control information being generated based on the target encrypted information, and enabling a debugging right in response to receiving the encrypted debugging control information.

According to some example embodiments of the present inventive concepts, AEAD decryption may be performed on the received encrypted debugging control information according to the first key to obtain decrypted debugging control information, and the debugging right may be enabled according to the decrypted debugging control information. Here, the debugged device performs the AEAD decryption on the encrypted debugging control information according to the first key, which may be represented as Debug_info=AEAD_DEC (Master_key, Enc_debug_info, AD2), where Debug_info is the decrypted debugging control information, Enc_debug_info is the encrypted debugging control information, and AD2 is second preset associated data.

Furthermore, the step of enabling (e.g., at the debugged device) the debugging right (e.g., the debugging function) according to the decrypted debugging control information may include: in response to obtaining the second preset associated data indicating that the debugging control information comes from a legitimate source from the encrypted debugging control information (e.gh, in response to a determination that the second preset associated data is received at the debugged device), enabling the debugging right according to the decrypted debugging control information. Here, after (e.g., in response to) determining that the debugging control information comes from (e.g., originates from, is received from, etc.) the legitimate source according to the second preset associated data bound with the encrypted debugging control information, that is, after (e.g., in response to) determining that the encrypted debugging control information comes from (e.g., originates from, is received from, etc.) the server, the debugged device may be debugged according to the decrypted debugging control information. Here, setting the first and second preset associated data in advance may reduce, minimize, or prevent replay attacks on the ciphertext. Since during a same authentication process, both the debugged device and the server use the same key (i.e. the first and second keys) to encrypt different messages, it is impossible to distinguish sources of the ciphertext during the decryption, resulting in a protocol anomaly.

By using the debugging method as described above, the first key is generated by using the public key corresponding to the device ID and based on the key encapsulation mechanism at first, then the credential information of the user is encrypted according to the first key, and further the information transmission is completed, and the security of the public key may be ensured by using the key encapsulation mechanism. At the same time, the AEAD encryption algorithm may be used to encrypt user credentials, thereby ensuring the security of user credential transmission. Meanwhile, the AEAD encryption algorithm may be used to encrypt the user credential, thereby ensuring security in transmitting the user credential. As a result, the security of the debugging method, and thus the security of the debugged device, the client, and/or the server may be improved.

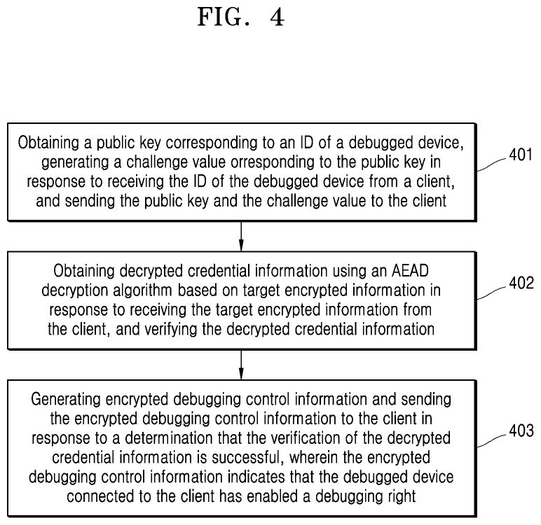

FIG. 4 is a flowchart illustrating a debugging method according to some example embodiments of the present inventive concepts. The debugging method as shown in FIG. 4 is applied to a server. For example, the debugging method as shown in FIG. 4 may be implemented by a server, including for example the server 103 shown in FIG. 1.

Referring to FIG. 4, in step 401, in response to receiving an ID of a debugged device from a client, a public key corresponding to the ID may be obtained and a challenge value corresponding to the public key may be generated, and the public key and challenge value may be sent to the client. Step 401 may include receiving, from a client, the ID of the debugged device, generating a challenge value corresponding to the public key in response to receiving the ID of the debugged device, and sending the public key and the challenge value to the client. Here, after (e.g., in response to) receiving the ID of the debugged device, the server may search for the public key corresponding to the ID in a database, generate the corresponding challenge value according to the searched public key, and then send the public key and challenge value to the client. The client may then forward the public key and challenge value to the debugged device.

In step 402, in response to receiving target encrypted information from the client, decrypted credential information may be obtained using an AEAD decryption algorithm based on the target encrypted information, and the decrypted credential information is verified. Step 402 may include receiving target encrypted information from the client, obtaining decrypted credential information using an AEAD decryption algorithm based on the target encrypted information in response to receiving the target encrypted information, and verifying the decrypted credential information. Here, after (e.g., in response to) sending the public key and the challenge value corresponding to the device ID to the client, the server obtains the decrypted credential information by performing the AEAD decryption algorithm on the target encrypted information when receiving the target encrypted information sent by the client, and verifies the credential information based on a received user credential.

According to some example embodiments of the present inventive concepts, the target encrypted information includes encrypted credential information and ciphertext. The step of obtaining (e.g., at the server) the decrypted credential information may include: obtaining a private key corresponding to the public key, and generating a second key using a key encapsulation mechanism based on the private key and the ciphertext; using the second key to perform the AEAD decryption on the encrypted credential information to obtain the decrypted credential information.

Here, after (e.g., in response to) receiving the target encrypted credential information, the server may search for the private key corresponding to the device ID in the database, and performing a key decapsulation on the received ciphertext using the searched private key to obtain the second key. That is, Master_key=KEM_DECAPS (SK, C), where Master_key is the second key, KEM_DECAPS is the key decapsulation algorithm, SK is the private key, and C is the ciphertext. Next, the decrypted credential information is obtained by using the second key to perform the AEAD decryption on the encrypted credential information. By using the key encapsulation mechanism to obtain the second key (the second key is the same as the first key) through the private key corresponding to the public key, and decrypting the encrypted credential information according to the second key, it (e.g., the debugging method, or the server, debugged device and/or client performing any portion thereof) may ensure that the keys obtained by both encryption and decryption parties are consistent during the decryption process, and relevant information of the first key is not leaked, thereby ensuring security of information transmission. As a result, the security of the debugging method and/or the decryption process may be improved, and thus the security of the debugged device, the client, and/or the server may be improved.

According to some example embodiments of the present inventive concepts, the step of obtaining the decrypted credential information may further include: obtaining first preset associated data contained in the encrypted credential information; and in response to the first preset associated data indicating that the encrypted credential information comes from the debugged device, decrypting the encrypted credential information using the second key to obtain the decrypted credential information.

Here, the first preset associated data in the encrypted credential information is obtained at first. After (e.g., in response to) verifying the first preset associated data successfully, it may be determined that the encrypted credential information comes from (e.g., originates from, is received from), etc.) the debugged device. Next, the AEAD decryption is performed on the encrypted credential information by using the second key to obtain the decrypted credential information. That is, Creds_hash=AEAD_DEC (Master_key, Enc_creds, AD1), where Creds_hash is the decrypted credential information, AEAD_DEC is the AEAD decryption algorithm, Master_key is the second key, Enc_creds is the encrypted credential information, and AD1 is the first preset associated data. Performing the AEAD decryption on the encrypted credential information through the first preset associated data and the second key may ensure privacy, integrity, and authenticity assurance of the decrypted credential information. As a result, the security of the debugging method and/or the decryption process may be improved, and thus the security of the debugged device, the client, and/or the server may be improved.

Referring to FIG. 4 again, in step 403, in response to the verification being successful (e.g., in response to a determination that the verification of the decrypted credential information is successful), encrypted debugging control information is generated and sent to the client, where the encrypted debugging control information indicates that the debugged device connected to the client has enabled a debugging right. Here, it is verified whether hash values of the user credential and the challenge value corresponding to the public key are consistent with the credential information at first. That is, ASSERT (hash (Creds|Challenge)==Creds_hash), where ASSERT is a verification algorithm, hash (Creds|Challenge) is the hash values of the user credential and challenge value, and Creds_hash is the decrypted credential information.

Furthermore, after (e.g., in response to a determination that) the verification is passed (e.g., successful), i.e. after (e.g., in response to a determination that) the hash values of the user credential and the challenge value are consistent with (e.g., match at least a portion of) the credential information, corresponding debugging control information may be obtained based on the decrypted credential information; AEAD encryption is performed on the debugging control information according to the second key to generate the encrypted debugging control information. Here, the corresponding debugging control information may be searched in the database according to the decrypted credential information, and the debugging control information may be encrypted using the second key to obtain the encrypted debugging control information.

In some example embodiments, the step of generating the encrypted debugging control information (e.g., at the server) may include: encrypting the debugging control information according to the second key and second preset associated data to generate the encrypted debugging control information. Specifically, Enc_debug_info=AEAD_ENC (Master_key, Debug_info, AD2), where Enc_debug_info is the encrypted debugging control information, Master_key is the second key, Debug_info is the debugging control information, AD2 is the second preset associated data, and the second preset associated data indicates that the encrypted debugging control information comes from the server responsible for granting the user the debugging right. Setting the first and second preset associated data in advance may reduce, minimize, or prevent replay attacks on the ciphertext. Since during a same authentication process, both the debugged device and the server use the same key to encrypt different messages, it is impossible to distinguish sources of the ciphertext during the decryption. As a result, the security of the debugging method and/or the decryption process may be improved, and thus the security of the debugged device, the client, and/or the server may be improved.

According to some example embodiments of the present inventive concepts, the credential information is generated based on the user credential and the challenge value, and the second key is the same as the first key generated by using the key encapsulation mechanism based on the public key. Here, the public and private keys use the key encapsulation mechanism to generate the same first and second keys, which may save (e.g., reduce or minimize) resource consumption while reducing running latency. As a result, performance of the debugged device, the client, the server, or any combination thereof may be improved (e.g., improved power consumption efficiency, reduced power consumption, improved operating speed, reduced latency of operations, or any combination thereof).

By using the debugging method as described above, the public key corresponding to the device ID and the challenge value are sent to the client at first. Then, the received encrypted credential information is decrypted based on the private key corresponding to the public key. Furthermore, the debugging control information of the debugged device is determined based on the decrypted credential information, the AEAD encryption is performed on the debugging control information using the second key, and the encrypted debugging control information is sent to the client, and then forwarded to the debugged device. In this way, security of the key may be ensured based on the private key and key encapsulation mechanism, and the AEAD encryption algorithm may also be used to ensure the security in transmitting the debugging control information. As a result, the security of the debugging method may be improved, and thus the security of the debugged device, the client, and/or the server may be improved.

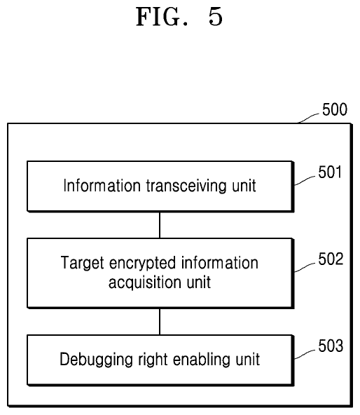

FIG. 5 is a block diagram illustrating an electronic apparatus according to some example embodiments of the present inventive concepts, and the electronic apparatus may be a debugged device.

Referring to FIG. 5, the electronic apparatus 500 includes an information transceiving unit 501, a target encrypted information acquisition unit 502, and a debugging right enabling unit 503. The information transceiving unit 501 may send an identifier (ID) of a debugged device to a client in response to receiving a debugging request from the client. The target encrypted information acquisition unit 502 may receive credential information and a public key corresponding to the ID from the client, obtain target encrypted information by using an Authenticated Encryption with Associated Data (AEAD) encryption algorithm based on the received public key and credential information, and send the target encrypted information to the client, where the credential information is generated based on a user credential and a challenge value corresponding to the public key. The target encrypted information acquisition unit 502 may be configured to receive, from the client, a public key corresponding to the ID and credential information, obtain target encrypted information by using an Authenticated Encryption with Associated Data (AEAD) encryption algorithm based on the received public key and the received credential information, and send the target encrypted information to the client, wherein the received credential information is generated based on a user credential and a challenge value corresponding to the public key. The debugging right enabling unit 503 may enable a debugging right (e.g., a debugging function) in response to receiving encrypted debugging control information from the client, where the encrypted debugging control information is generated based on the target encrypted information. The debugging right enabling unit 503 may be configured to receive encrypted debugging control information from the client, the encrypted debugging control information being generated based on the target encrypted information, and enable a debugging right in response to receiving the encrypted debugging control information. As described herein, an information transceiving unit may include a wireless network communication interface, a wired network communication interface, or any combination thereof.

In some example embodiments, the target encrypted information acquisition unit 502 may verify the received public key based on pre-stored public key information; and obtain the target encrypted information using the Authenticated Encryption with Associated Data (AEAD) encryption algorithm based on the received public key and credential information, in response to the verification being successful (e.g., in response to a determination that the verification of the received public key is successful).

In some example embodiments, the target encrypted information acquisition unit 502 may generate a first key and corresponding ciphertext by using a key encapsulation mechanism based on the public key; perform AEAD encryption on the credential information according to the first key to obtain the encrypted credential information; and use the encrypted credential information and the ciphertext as the target encrypted information.

In some example embodiments, the target encrypted information acquisition unit 502 may encrypt the credential information according to the first key and first preset associated data to obtain the encrypted credential information, where the first preset associated data indicates that the encrypted credential information comes from (e.g., originates from, is received from, etc.) the debugged device.

In some example embodiments, the debugging right enabling unit 503 may perform AEAD decryption on the encrypted debugging control information according to the first key to obtain decrypted debugging control information, and enable the debugging right according to the decrypted debugging control information.

In some example embodiments, the debugging right enabling unit 503 may enable the debugging right according to the decrypted debugging control information, in response to obtaining second preset associated data indicating that the debugging control information comes from (e.g., originates from, is received from, etc.) a legitimate source from the encrypted debugging control information.

As for the electronic apparatus in some example embodiments, including the example embodiments shown in FIG. 5, specific ways in which each unit performs operations have been described in detail in the relevant method according to some example embodiments, including the example embodiments shown in any of FIGS. 2 to 4 or any combination thereof, and will not be described in detail here.

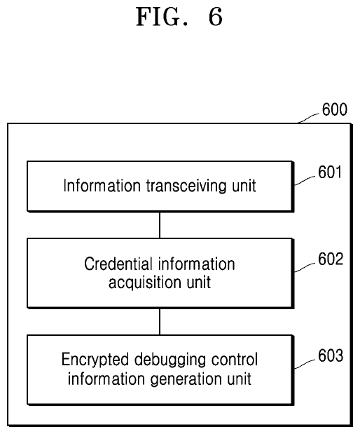

FIG. 6 is a block diagram illustrating an electronic apparatus according to some example embodiments of the present inventive concepts, and the electronic apparatus may be a server.

Referring to FIG. 6, the electronic apparatus 600 includes an information transceiving unit 601, a credential information acquisition unit 602, and an encrypted debugging control information generation unit 603. The information transceiving unit 601 may obtain a public key corresponding to an identifier (ID) of a debugged device (e.g., a device ID) and generate a challenge value corresponding to the public key in response to receiving the ID from a client, and send the public key and challenge value to the client; the credential information acquisition unit 602 may obtain decrypted credential information using an AEAD decryption algorithm based on target encrypted information in response to receiving the target encrypted information from the client, and verify the decrypted credential information; the encrypted debugging control information generation unit 603 may generate encrypted debugging control information and send the encrypted debugging control information to the client in response to the verification being successful, where the encrypted debugging control information indicates that the debugged device connected to the client has enabled a debugging right. The information transceiving unit 601 may be configured to obtain a public key corresponding to an identifier (ID) of a debugged device, receive, from a client, the ID of the debugged device, generate a challenge value corresponding to the public key in response to receiving the ID of the debugged device, and send the public key and the challenge value to the client. The credential information acquisition unit 602 may be configured to receive target encrypted information from the client, obtain decrypted credential information using an AEAD decryption algorithm based on the target encrypted information in response to receiving the target encrypted information, and verify the decrypted credential information. The encrypted debugging control information generation unit 603 may be configured to generate encrypted debugging control information and send the encrypted debugging control information to the client in response to a determination that the verification of the decrypted credential information is successful, wherein the encrypted debugging control information indicates that the debugged device connected to the client has enabled a debugging right.

In some example embodiments, the target encrypted information includes encrypted credential information and ciphertext, where the credential information acquisition unit 602 may obtain a private key corresponding to the public key, generate a second key using a key encapsulation mechanism based on the private key and the ciphertext, and perform the AEAD decryption on the encrypted credential information by using the second key to obtain the decrypted credential information.

In some example embodiments, the credential information acquisition unit 602 may obtain first preset associated data contained in the encrypted credential information; and decrypt the encrypted credential information using the second key to obtain the decrypted credential information, in response to the first preset associated data indicating that the encrypted credential information comes from the debugged device.

In some example embodiments, the encrypted debugging control information generation unit 603 may obtain corresponding debugging control information based on the decrypted credential information; and perform AEAD encryption on the debugging control information according to the second key to generate the encrypted debugging control information.

In some example embodiments, the encrypted debugging control information generation unit 603 may encrypt the debugging control information according to the second key and second preset associated data to generate the encrypted debugging control information, where the second preset associated data indicates that the encrypted debugging control information comes from (e.g., originates from, is received from, etc.) a preset server responsible for granting the user the debugging right.

As for the electronic apparatus in some example embodiments, including the example embodiments shown in FIG. 5, specific ways in which each unit performs operations have been described in detail in the method according to some example embodiments, including the example embodiments shown in any of FIGS. 2 to 4 or any combination thereof, and will not be described in detail here.

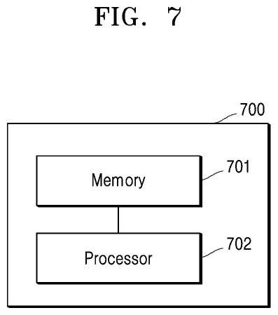

FIG. 7 is a block diagram illustrating an electronic apparatus according to some example embodiments of the present inventive concepts. Here, the electronic apparatus may be a debugged device or a server as described above.

Referring to FIG. 7, the electronic apparatus 700 may include at least one memory 701 and at least one processor 702. The at least one memory 701 may store computer executable instructions that, when executed by the at least one processor 702, cause the at least one processor 702 to execute the debugging method according to some example embodiments of the present inventive concepts.

As an example, the electronic apparatus 700 may be a PC, a tablet device, a personal digital assistant, a smart phone or other devices capable of executing the above instruction set. For example, the electronic apparatus 700 may connect to a wireless LAN. Here, the electronic apparatus 700 does not have to be a single electronic apparatus, but may also be an assembly of any device or circuit capable of executing the above instructions (or instruction set) alone or jointly. The electronic apparatus 700 may also be a part of an integrated control system or system manager, or may be configured as a portable electronic apparatus interconnected with local or remote (e.g., via wireless transmission) by an interface.

In the electronic apparatus 700, the processor 702 may include a central processing unit (CPU), a graphics processing unit (GPU), a programmable logic device, a dedicated processor system, a microcontroller, or a microprocessor. By way of example, the processor 702 may also include an analog processor, a digital processor, a microprocessor, a multi-core processor, a processor array, a network processor, etc.

The processor 702 may run instructions or codes stored in the memory 701, wherein the memory 701 may further store data. Instructions and data may further be transmitted and received through the network via a network interface device, wherein the network interface device may adopt any known transmission protocol.

The memory 701 may be integrated with the processor 702. For example, the memory 701 may be a RAM or a flash memory arranged in an integrated circuit microprocessor and the like. In addition, the memory 701 may include independent devices, such as an external disk drive, a storage array, or other storage devices that may be used by any database system. The memory 701 and the processor 702 may be operatively coupled, or may communicate with each other, for example, through an I/O port, a network connection, etc., so that the processor 702 may read files stored in the memory 701.

In addition, the electronic apparatus 700 may also include a video display (for example, a liquid crystal display) and a user interaction interface (such as a keyboard, a mouse, a touch input device, etc.). All components of the electronic apparatus may be connected to each other via a bus and/or network.

According to some example embodiments of the present inventive concepts, there is also provided a computer readable storage medium storing computer executable instructions that, when executed by the at least one processor, cause the at least one processor to execute the debugging method according to some example embodiments of the present inventive concepts. Examples of the computer readable storage medium include: read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), a card type memory such as multimedia card, secure digital (SD) card or extreme digital (XD) card, magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the computer program. The computer program in the above-mentioned computer readable storage medium may run in an environment deployed in computer equipment such as a client, a host, an agent device, a server, etc. In addition, the computer program and any associated data, data files, and data structures are distributed over network-coupled computer systems so that the computer program and any associated data, data files, and data structures are stored, accessed, and executed in a distributed fashion by one or more processors or computers.

The debugging method, the electronic apparatus, and the computer readable storage medium according to some example embodiments of the present inventive concepts may utilize the key encapsulation mechanism to ensure the security of the public key by generating the first key using the public key corresponding to the device ID and based on the key encapsulation mechanism at first, then encrypting the credential information of the user according to the first key, and further completing information transmission, through the debugging method. Meanwhile, the AEAD encryption algorithm may also be used to encrypt the user credential, thereby ensuring the security of transmitting the user credential. As a result, the security of the debugging method may be improved, and thus the security of the debugged device, the client, and/or the server may be improved.

As described herein, any devices, systems, modules, portions, units, controllers, circuits, and/or portions thereof according to any of the example embodiments, and/or any portions thereof (including, without limitation, the debugged device 101, the chip ID storage unit 1011, the first PQC engine unit 1012, the debugging unit 1013, the client 102, the debugging program unit 1021, the server 103, the calculation module 1031, the second PQC engine unit 1033, the database 1032, the debugged device information storage unit 1034, the user information storage unit 1035, the debugging information storage unit 1036, the electronic apparatus 500, the information transceiving unit 501, the target encrypted information acquisition unit 502, the debugging right enabling unit 503, the electronic apparatus 600, the information transceiving unit 601, the credential information acquisition unit 602, the encrypted debugging control information generation unit 603, the electronic apparatus 700, the at least one memory 701, the at least one processor 702, any portion thereof, or the like) may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

While the present inventive concepts include specific examples, it will be apparent to one of ordinary skill in the art that various changes in form and details may be made in these examples without departing from the spirit and scope of the claims and their equivalents. The examples disclosed herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the present inventive concepts is defined not by the detailed description, but by the claims and their equivalents, and all variations within the scope of the claims and their equivalents are to be construed as being included in the present inventive concepts.

1. A debugging method, comprising:
sending an identifier (ID) of a debugged device to a client in response to receiving a debugging request from the client;
receiving, from the client, a public key corresponding to the ID of the debugged device and credential information;
obtaining target encrypted information by using an Authenticated Encryption with Associated Data (AEAD) encryption algorithm based on the received public key and the received credential information;
sending the target encrypted information to the client, wherein the received credential information is generated based on a user credential and a challenge value corresponding to the received public key;
receiving encrypted debugging control information from the client, the encrypted debugging control information being generated based on the target encrypted information; and
enabling a debugging right in response to receiving the encrypted debugging control information.

2. The debugging method of claim 1, wherein the obtaining of the target encrypted information by using the Authenticated Encryption with Associated Data (AEAD) encryption algorithm based on the received public key and the received credential information, comprises:
verifying the received public key based on pre-stored public key information; and
obtaining the target encrypted information using the Authenticated Encryption with Associated Data (AEAD) encryption algorithm based on the received public key and the received credential information, in response to a determination that the verification of the received public key is successful.

3. The debugging method of claim 2, wherein the obtaining of the target encrypted information by using the Authenticated Encryption with Associated Data (AEAD) encryption algorithm based on the received public key and the received credential information, comprises:
generating a first key and corresponding ciphertext by using a key encapsulation mechanism based on the received public key;
performing AEAD encryption on the received credential information according to the first key to obtain encrypted credential information; and
using the encrypted credential information and the corresponding ciphertext as the target encrypted information.

4. The debugging method of claim 3, wherein the performing of AEAD encryption on the credential information according to the first key, comprises:
encrypting the credential information according to the first key and first preset associated data to obtain the encrypted credential information, wherein the first preset associated data indicates that the encrypted credential information comes from the debugged device.

5. The debugging method of claim 3, wherein the enabling of the debugging right in response to receiving the encrypted debugging control information from the client, comprises:
performing AEAD decryption on the encrypted debugging control information according to the first key to obtain decrypted debugging control information, and enabling the debugging right according to the decrypted debugging control information.

6. The debugging method of claim 5, wherein the enabling of the debugging right according to the decrypted debugging control information, comprises:
enabling the debugging right according to the decrypted debugging control information, in response to obtaining second preset associated data indicating that the debugging control information comes from a legitimate source from the encrypted debugging control information.

7. A debugging method, comprising:
obtaining a public key corresponding to an identifier (ID) of a debugged device;
receiving, from a client, the ID of the debugged device;
generating a challenge value corresponding to the public key in response to receiving the ID of the debugged device;
sending the public key and the challenge value to the client;
receiving target encrypted information from the client;
obtaining decrypted credential information using an AEAD decryption algorithm based on the target encrypted information in response to receiving the target encrypted information;
verifying the decrypted credential information; and
generating encrypted debugging control information and sending the encrypted debugging control information to the client in response to a determination that the verification of the decrypted credential information is successful, wherein the encrypted debugging control information indicates that the debugged device connected to the client has enabled a debugging right.

8. The debugging method of claim 7, wherein
the target encrypted information comprises encrypted credential information and ciphertext, and
the obtaining of the decrypted credential information using the AEAD decryption algorithm based on the target encrypted information comprises:
obtaining a private key corresponding to the public key, and generating a second key using a key encapsulation mechanism based on the private key and the ciphertext; and
performing AEAD decryption on the encrypted credential information by using the second key to obtain the decrypted credential information.

9. The debugging method of claim 8, wherein the performing of the AEAD decryption on the encrypted credential information by using the second key to obtain the decrypted credential information, comprises:
obtaining first preset associated data contained in the encrypted credential information; and
decrypting the encrypted credential information using the second key to obtain the decrypted credential information, in response to a determination that the first preset associated data indicates that the encrypted credential information comes from the debugged device.

10. The debugging method of claim 8, wherein the generating of the encrypted debugging control information comprises:
obtaining corresponding debugging control information based on the decrypted credential information; and
performing AEAD encryption on the corresponding debugging control information according to the second key to generate the encrypted debugging control information.

11. The debugging method of claim 10, wherein the performing of the AEAD encryption on the debugging control information according to the second key to generate the encrypted debugging control information, comprises:
encrypting the debugging control information according to the second key and second preset associated data to generate the encrypted debugging control information, wherein the second preset associated data indicates that the encrypted debugging control information comes from a preset server responsible for granting a user the debugging right.

12. The debugging method of claim 8, wherein the decrypted credential information is generated based on a user credential and the challenge value, and the second key is a same key as a first key generated by using the key encapsulation mechanism based on the public key.

13. An electronic apparatus, comprising:
an information transceiving unit, configured to send an identifier (ID) of a debugged device to a client in response to receiving a debugging request from the client;
a target encrypted information acquisition unit, configured to
receive, from the client, a public key corresponding to the ID and credential information,
obtain target encrypted information by using an Authenticated Encryption with Associated Data (AEAD) encryption algorithm based on the received public key and the received credential information, and
send the target encrypted information to the client, wherein the received credential information is generated based on a user credential and a challenge value corresponding to the public key; and
a debugging right enabling unit, configured to
receive encrypted debugging control information from the client, the encrypted debugging control information being generated based on the target encrypted information, and
enable a debugging right in response to receiving the encrypted debugging control information.

14. The electronic apparatus of claim 13, wherein the target encrypted information acquisition unit is configured to:
verify the received public key based on pre-stored public key information; and
obtain the target encrypted information using the Authenticated Encryption with Associated Data (AEAD) encryption algorithm based on the received public key and the received credential information, in response to a determination that the verification of the received public key is successful.

15. The electronic apparatus of claim 14, wherein the target encrypted information acquisition unit is further configured to:
generate a first key and corresponding ciphertext by using a key encapsulation mechanism based on the public key;
perform AEAD encryption on the received credential information according to the first key to obtain encrypted credential information; and
use the encrypted credential information and the corresponding ciphertext as the target encrypted information.

16. The electronic apparatus of claim 15, wherein the target encrypted information acquisition unit is further configured to: encrypt the received credential information according to the first key and first preset associated data to obtain the encrypted credential information, wherein the first preset associated data indicates that the encrypted credential information comes from the debugged device.

17. The electronic apparatus of claim 15, wherein the debugging right enabling unit is configured to:
perform AEAD decryption on the encrypted debugging control information according to the first key to obtain decrypted debugging control information, and
enable the debugging right according to the decrypted debugging control information.

18. The electronic apparatus of claim 17, wherein the debugging right enabling unit is further configured to: enable the debugging right according to the decrypted debugging control information, in response to obtaining second preset associated data indicating that the debugging control information comes from a legitimate source from the encrypted debugging control information.

19-24. (canceled)

25. An electronic apparatus, comprising:
at least one memory storing computer executable instructions; and
at least one processor, configured to execute the computer executable instructions to perform the debugging method of claim 1.

26. A computer readable storage medium storing computer executable instructions that, when executed by at least one processor, cause the at least one processor to perform the debugging method of claim 1.
